(19) United States
(12) Patent Application Publication
(10) Pub. No.: US 2018/0372090 A1
(43) Pub. Date: Dec. 27, 2018

(54) PISTON-CHAMBER COMBINATION

(71) Applicants: Nicolaas VAN DER BLOM, Unterägeri (CH); NVB PROPULSION INTERNATIONAL LTD, Berkshire (GB)

(72) Inventor: Nicolaas VAN DER BLOM, Unterägeri (CH)

(21) Appl. No.: 15/778,521

(22) PCT Filed: Nov. 24, 2015
(86) PCT No.: PCT/IB2015/002212

§ 371 Date: May 23, 2018

(51) Int. Cl. F04B 53/14; F16F 9/48; F16J 3/06; F16J 10/02

(52) U.S. Cl. CPC F04B 53/143; F16J 10/02; F16J 3/06; F16F 9/483

(57) ABSTRACT

A piston-chamber combination including a chamber (2) which is bounded by an inner chamber wall (4), and including a piston (1) in the chamber (2) to be engagingly movable relative to the chamber wall (4) at least between a first position and a second position of the chamber (2), the chamber (2) having cross-sections of different cross-sectional areas and differing circumferential lengths at the first and second longitudinal positions, and at least substantially continuously different cross-sectional areas and circumferential lengths at intermediate longitudinal positions between the first and second longitudinal positions, the cross-sectional area and circumferential length at the second longitudinal position being smaller than the cross-sectional area and circumferential length at the first longitudinal position, and the piston (1) includes a rotatable member (12) for suspension of the sealing (8,9).

### CROSS REFERENCE TO RELATED APPLICATIONS

This application is a United States National Phase Application of International Application PCT/IB2015/002212, filed Nov. 24, 2015, the entire contents of which are incorporated herein by reference.

### TECHNICAL FIELD

A piston-chamber combination comprising a chamber which is bounded by an inner chamber wall, and comprising a piston in said chamber to be engagingly movable relative to said chamber wall at least between a first position and a second position of the chamber, said chamber having cross-sections of different cross-sectional areas and differing circumferential lengths at the first and second longitudinal positions, and at least substantially continuously different cross-sectional areas and circumferential lengths at intermediate longitudinal positions between the first and second longitudinal positions, the cross-sectional area and circumferential length at said second longitudinal position being smaller than the cross-sectional area and circumferential length at said first longitudinal position, said piston comprises a member for suspension of the sealing, said member is rotatable, and said sealing comprises a separate part engaging the wall of said chamber and a sealing made of elastically deformable impervious material, and mounted on the piston rod.

### BACKGROUND OF THE INVENTION

This invention deals with solutions for pistons in general, and specifically concerning reliability and life time.

In order to optimize the reduction in working force of a piston pump, the difference in cross-sectional areas at a first longitudinal/circular position and that of a second longitudinal/circular position should be as big as possible. This demand is contrary the life time and reliability demand of the elastically deformable material of a piston, of which at least a (separate) part is sealingly engaging the wall of said chamber (WO 00/70227, WO2013/026508). Specifically e.g. of a fast moving piston will the 3-dimensional change in size of the material of the sealing become a limit for the speed of the piston, for the energy used and for the life time.

WO00/70227 shows longitudinal chambers with a constant circumference where the change of the dimensions of the material of a piston within said chambers is solely 2-dimensional, as the sealing of said last mentioned pistons is only bending, so that the maximum speed of said pistons may be higher than those where a 3-dimensional change of the dimensions of the sealing is necessary.

However, chambers with a constant circumference may not be easy to produce, and may therefore be expensive.

### OBJECT OF THE INVENTION

The object is to provide an optimalization of the functioning of any kind of a combination of a piston and a chamber, and in particular as a pump.

### SUMMARY OF THE INVENTION

In the first aspect, the invention relates to a combination of a piston and a chamber, wherein: one end, closest to a second longitudinal/circular position of the chamber, the sealing of said piston is embedded in a separate part, said separate part is sealingly engaging the wall of said chamber, at least from a first- to a second longitudinal/circular position of the chamber, wherein said sealing of the piston is built up by (e.g. plane) sections of which, at least at a second longitudinal/circular position, the in-between angles are less than 180°.

The basis of this new construction design of the piston is that of FIGS. 5A-5H of WO00/70227, the entire contents of which are hereby incorporated by reference, and regarding said separate part it is FIGS. 80A-J and FIGS. 81A-D of WO2013/026508, the entire contents of which are hereby incorporated by reference.

The separate part is comprising a sealing means e.g. an O-ring which has a bigger cross-sectional area in a cross-section through the center axis of said chamber, which may be elongate or circular, at a second longitudinal/circular position of said chamber, than its cross-section at a first longitudinal/circular position. Said O-ring is preferably attached to at least one of the members with reference number 43 (WO00/70227), so that it can then expand its circumferential length from said attachment point of at least one member 43, whereby its cross-sectional area in a plane through the center axis of the piston, will become smaller, when extended, when said piston is moving from a second to a first longitudinal/circular position of the chamber. When said sealing of the piston is embedded in said O-ring, in such a way, that the sealing can change shape by solely bending the elastically deformable material of said sealing, instead of a 3-dimensional change of its size by stretching said material, when said piston is moving from a second to a first longitudinal/circular position, the life time of said sealing can be extended very much, while the change of the size of the sealing of the piston according to similar changes of the size of the wall of the chamber can be performed much quicker and with less energy used. At a second longitudinal/circular position of the chamber may the sealing sections of said sealing be preferably formed as folded planes, when unpressurized, like that of a shade. Another preferred form of the sealing section is that of a curve. When said piston is moving to a first longitudinal/circular position, the common line, the fold, in-between two adjacent sections of the shade formed sealing of the piston will become farther away from each other, because the circumference of the material of the O-ring is being extended. Thus, the in-between angles of plane sections, having a common folding line closest to the sealing of said piston, which may be less than 180° or 90° or 45° at said second longitudinal/circular position of the chamber, are becoming bigger. Said angles, when the piston has arrived at a first longitudinal/circular position, may preferably become less than 180°, in order to enabling backwards folding of the plane sections of said piston sealing, when the piston is moving towards a second longitudinal position. This is also valid for a similar angle between centres of curves of a curved sealing. Other section forms than plane or curved may also be possible.

In a second aspect the invention relates to a combination of a piston and a chamber wherein the sealing is shaped like that of a shade.

Thus the sealing of the piston may comprise several adjacent wall sections, continuously positioned along the circumference of said sealing, which may preferably be plane, which have an in-between angle less than 180° in a cross-section of the shade formed sealing sections of said piston, in a plane which is perpendicular to the fold of two said adjacent wall sections. The above mentioned in this sub-chapter is also valid for curved sections.

In a third aspect the invention relates to a combination of a piston and a chamber, wherein the reinforcement of said sealing is positioned at least in a fold of said shade.

A non-stressed sealing of the piston makes it vulnerable for forces working approximately perpendicular on its surface, which is why it is necessary to reinforce it. The reinforcement may comprise several closely lying reinforcement strings from the turning point of said sealing approximately parallel to a common folding line in-between adjacent sections of said sealing, and ending in said O-ring. At least said common folding line should comprise such a string as reinforcement. It is also preferable to have additional reinforcements, positioned in a certain angle (e.g. 90°) to said reinforcement strings. This may also be valid for curved sealings.

In a fourth aspect the invention relates to a combination of a piston and a chamber, wherein the sealing of said piston in a longitudinal/circular cross-section of said chamber is at least approximately 60° with the central axis of said chamber.

As an additional solution for the problem of minimilization of the stresses of the elastically deformable sealing material of the sealing of the piston, may the length of said sealing of the piston projected to a plane through the central axis, be bigger than the radius of the chamber. A preferred angle between the sealing of said piston and the central axis of the chamber may be approximately 60°. A bigger angle may be an option, but this will reduce the stroke length, and thus the stroke volume, and thus the pumping speed.

In another way, in order to avoid stressing the elastically deformable material of the sealing the turning point of the member may be nearby the end of the vulcanization stroke of said sealing on the piston rod, which is the turning point of the shade formed sealing. This may be done virtually as well, due to the fact that the turning point of said member is difficult to merge with the end of a vulcanization stroke. When combined with e.g. the shade formed sealing of the piston may the life time of the piston be optimized.

In a fifth aspect the invention relates to a combination of a piston and a chamber, wherein each section of the shade formed sealing of the piston comprises a reinforcement, said reinforcement lying outside a common folding line in-between adjacent sections of said shade shaped sealing. Because the sections are not changing size in a direction in relation to the center axis of the chamber, said sections may comprise a reinforcement which may prevent the section to bend of even deform in 3-dimensions under pressure.

For a good fuctionning of the piston is it necessary that the O-ring is following the shape (in case of constant circumference type chamber) and/or the size of the chamber wall (in case of a chamber with a preferred circular transitional cross-sectional section), when the piston is moving from a 2^{nd} to a 1^{st} position of said chamber. In a pump where only the pumping stroke is from 1^{st} to 2^{nd} chamber positions, during a stroke from 2^{nd} to 1^{st} positions the O-ring may preferably be engagingly-, but not be sealingly communicating with the wall of said chamber—in order to lower friction forces. The shown coil spring is providing this support, and said spring may be fastened to one or more members. During the pumping stroke there will be overpressure under the piston seal, which will push the sealing outwards towards the O-ring, the last mentioned being pushed to the wall of the chamber, now communicating sealingly with the wall of said chamber.

For a continuously good functioning of the piston a correctly folding back of said shade sealing is necessary, when the piston is performing a pumping stroke (1^{st}→2^{nd} position of the chamber).

The folding back will go inwards, while under internal (over) pressure. Said overpressure may prohibit an intended folding back—however, this will not influence the piston function as such, when the sealing sections and the folds do not begin to communicate with the wall of said chamber, which would give friction and lower life time of said sealing. In order to support an intended folding back, the folds but also the sections of the sealing may comprise reinforcement strings. Firstly when the pressurized medium has exited the chamber, reducing the overpressure inside the piston, a ‘blown up’ sealing will fold back to its production size. A solution for obtaining a correct folding back during the pumping stroke, may be that there is a seal embedded in the O-ring, which is existing in a transitional cross-section of the piston. Here may also be folds existing like a shade, according to the shape of a seal in a foam piston of FIG. 7B of WO2000/065235, the entire contents of which are hereby incorporated by reference, in order to prevent 3D-stretching, enhancing its life time. The piston may than have a venting hole from the internal space within the sealings and the piston rod to the atmosphere, so that the piston internally can ‘breath’, avoiding undesired overpressure. The size of said venting hole may be tuned in such a way that there is a little overpressure, so that the O-ring during the pumping stroke is sealingly communicating with the wall of the chamber. The above mentioned in this sub-chapter may also be valid for curved sealing sections.

The chamber, which very well can be combined with these preferred embodiments of the piston, is of a classic type with continuous circular transitional cross-sections, thus less expensive than those for pistons having a constant circumference of the contact area of the sealing with the chamber.

In a sixth aspect the invention relates to a combination of a piston and a chamber, wherein the member may have a changeable length, by means of a portion which is retractable, e.g. at a second longitudinal/circular position of the chamber, due to a non-merge of turning points for the sealing and the member.

The purpose of a piston-chamber combination defines when a piston needs to be sealingly communicating with the wall of the chamber. In a pump, preferably this should happen when the piston is moving from a first to a second longitudinal/circular position of the chamber. In an actuator this should preferably happen when the piston is moving from a second to a first longitudinal/circular position of the chamber. When the actuator is comprising two pistons, the movement can also be from a first to a second longitudinal/circular position of the chamber. In a shock absorber it may preferably be to have the piston sealingly communicating with the wall of the chamber when the oil inside needs to be compressed—this may be preferably both from a second to a first longitudinal/circular position of the chamber and from a first to a second longitudinal/circular position of the chamber, optionally from a first to a second longitudinal/circular position of the chamber.

### BRIEF DESCRIPTION OF THE DRAWINGS

In the following, preferred embodiments of the invention will be described with reference to the drawings wherein:

FIG. 1 is a view of left of the central axis a longitudinal cross-section of a piston at a first longitudinal position of an elongate chamber—at the right side of said axis, the same, but now at a second longitudinal/circular position of the chamber;

FIG. 2 is a top view at the left of the central axis and a bottom view at the right of the suspension of the members at the piston rod for the support of the O-ring;

FIG. 3A is a scaled up view X of FIG. 1, of the difference in the folding of the sealing of the piston at first and second longitudinal/circular positions of the chamber;

FIG. 3B is an enlarged view of the folding of the sealing of said piston shown in FIG. 3A at a first longitudinal/circular position of the chamber;

FIG. 3C is an enlarged view of the folding of the sealing of said piston at a second longitudinal/circular position of the chamber, shown in FIG. 3A;

FIG. 4A is a scaled up view X of FIG. 1, of the difference in the enrolling of the sealing of the piston at first and second longitudinal/circular positions of the chamber;

FIG. 4B is an enlarged view of the production size and shape of the sealing of said piston shown in FIG. 4A at a second longitudinal/circular position of the chamber;

FIG. 5A is a detailed view of FIG. 1 of the sealing and assembly of the O-ring, when the piston is at a 1^{st} longitudinal/circular position of the chamber;

FIG. 5B is a detailed view of FIG. 1 of the sealing and assembly of the O-ring, when the piston is at a 2^{nd} longitudinal/circular position of the chamber;

FIG. 5C is a view showing the suspension of the O-ring by a member;

FIG. 6 is a view showing an alternative suspension of the O-ring by a flat spring;

FIG. 7 is a view of the piston of FIG. 1, now further comprising a sealing surface embedded in the O-ring and vulcanized to the piston rod;

FIG. 8A is a view showing a part of a plane-type sealing surface with a fold, and reinforcement strings; and

FIG. 8B is a view showing a part of a curve-type sealing surface with reinforcement strings.

### DESCRIPTION OF PREFERRED EMBODIMENTS

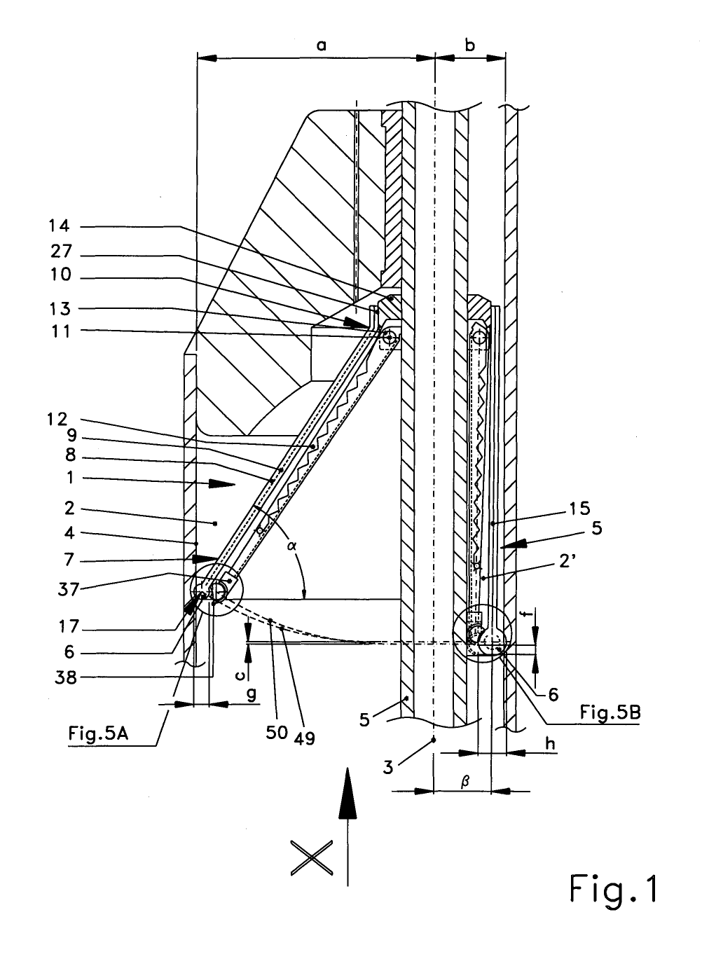

FIG. 1 shows two longitudinal cross-sections of a piston 1, 1′ in an elongate chamber 2, the center axis 3 of said chamber 2, 2′, the internal wall 4 of the chamber 2, the piston rod 5, the O-ring 6 (at a first longitudinal position) and 6′ (at a second longitudinal position). In said O-ring 6, 6′ is a sealing 7 embedded, comprising an impervious layer 8 and a reinforcement layer 9. Said O-ring is vulcanized to the piston rod 5 at spot 10. Other forms of mounting the piston on the piston rod 5 are possible, e.g. on a cylinder formed end which has within an O-ring (as shown in WO2000/070227, the entire contents of which are hereby incorporated by reference), wherein said cab is mounted within a pair of closing rings, which have been mounted on the piston rod. Very nearby said spot 10 is the center 11 of the turning point 11 of the arm 12, which supports said O-ring. Said turning point comprises an axel 13 and a suspension 14 of the arm 12. Said suspension 14 is sealingly mounted on the piston rod 5.

The cross-section of the piston 6 and the chamber 2 is shown left of the center axis 3. The radius of said chamber 2 is at said first longitudinal position ‘a’. The angle α is the angle between the line 15 straight between centers of the turning points 11 and the center 17 of the O-ring 6 of the member 12 and a horizontal line 16 which is perpendicular to the center axis 3. The diameter x of said O-ring 6 has been reduced substantially in relation to the diameter y of said O-ring 6′ at a second longitudinal position. The circle segment ‘t’ shows the movement of the center 17 of said O-ring when said piston is moving between first and second longitudinal positions. The circle segment ‘s’ shows the rotation of arm 12, turning around said axle 13 through the center 17 of said O-ring when said piston 1 is moving between first and second longitudinal positions. The circle segment ‘t’ shows the rotation around the middle of the sealing just under the bottom of the vulcanization on said piston rod 5 of the center 17 of said O-ring when said piston 1 is moving between first and second longitudinal positions. The difference ‘c’ at a second longitudinal position shows that the sealing is stretched a length ‘c’ in comparison with the sealing length at a first longitudinal position. Said difference ‘c’ needs to be as small as possible, in order to avoid stressing the sealing, thereby enhancing life time. The traject curves 49 and 50 of the centers 17 and 48, of the coil spring 34 and the O-ring 6,6′, respectively when the piston is moving from a first- to a second longitudinal/circular position of the chamber.

The cross-section at a second longitudinal position is showing right of the center axis 3 the piston 1′ at a second longitudinal position of said chamber 2′. The radius of said chamber 2′ is at said second longitudinal position ‘b’. The angle β is the angle between the line 15 and the center axis 3 of the piston 1′. ‘g’ is the diameter of the O-ring 6 at the first longitudinal/circular position, which is smaller than ‘h’, which is the diameter of the O-ring 6′ at a second longitudinal/circular position. Both diameters are measured in a cross-section in a plane through the center axis 3 of the chamber 2, 2′.

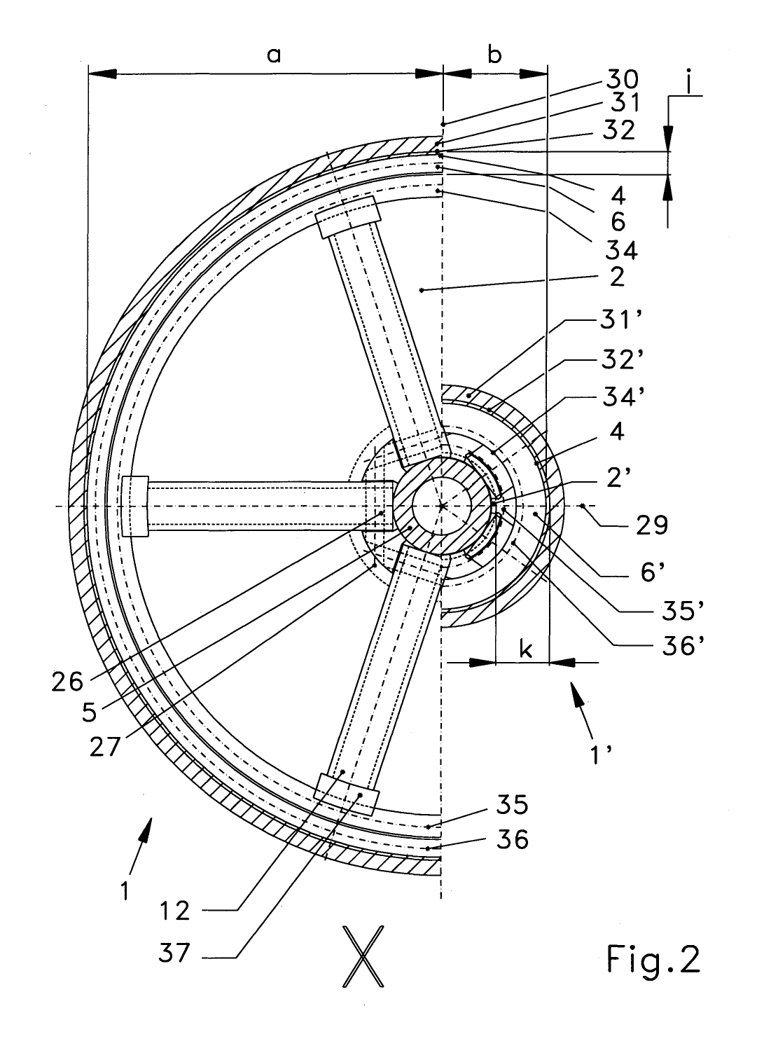

View X is shown in FIGS. 2, 3A and 4A.

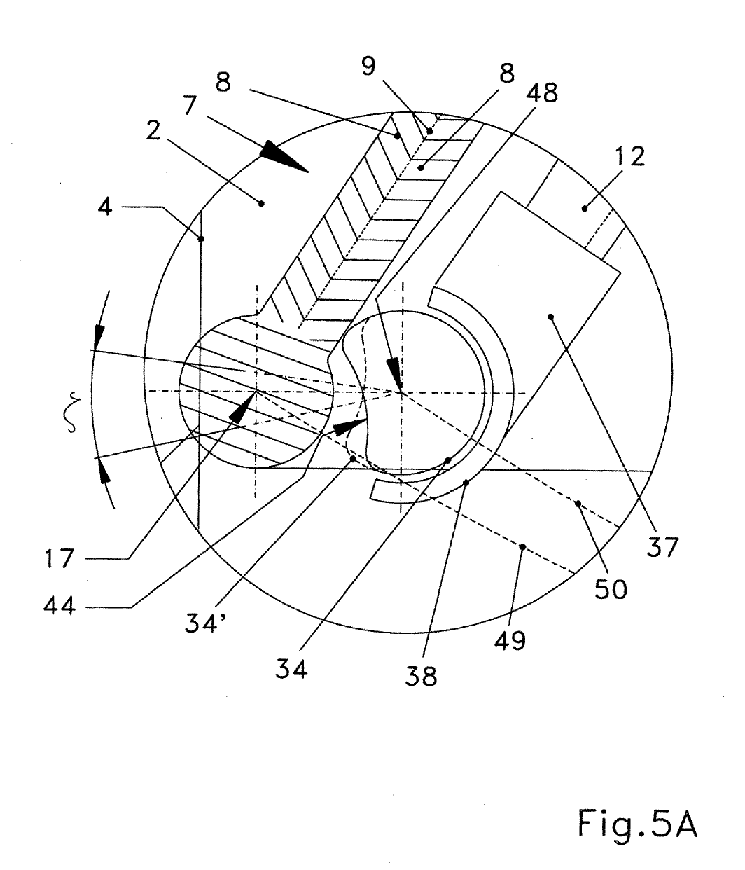

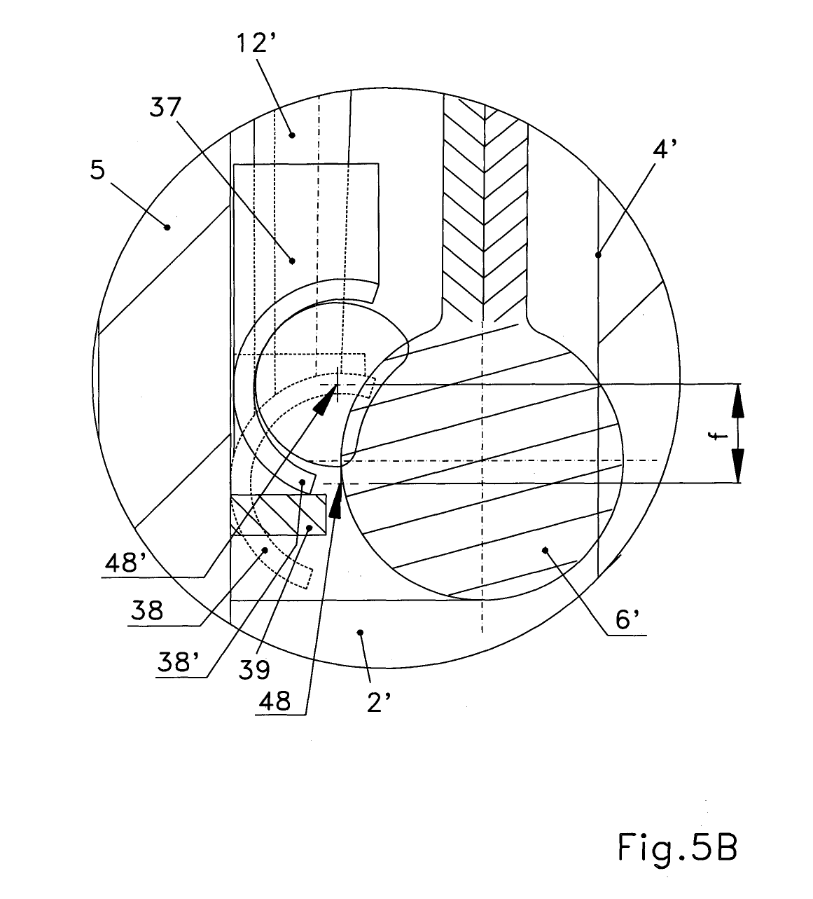

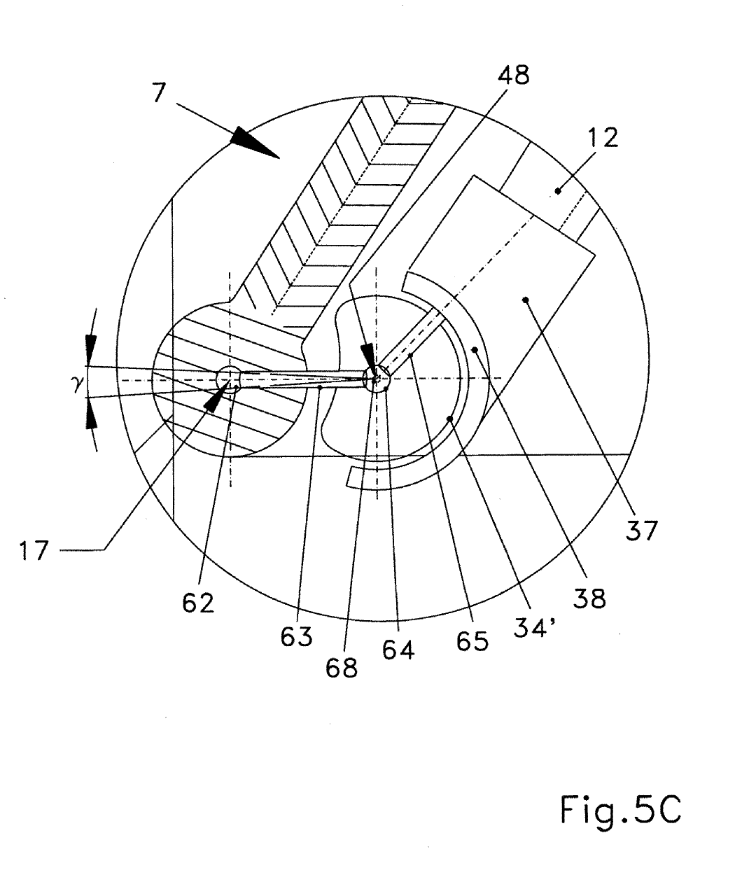

The coil spring 34 (see also WO2000/070227) which is pressing the O-ring 6, 6′ onto the internal wall 4 of the chamber 2, is shaped such, that O-ring 6, 6′ is supported in pressing itself onto said internal wall, thereby enabling a proper sealing. Said spring is suspended by a holder 38 at the end of the member 12. At a 1^{st} position of the chamber is said member positioned at the very end of said arm 12. At a 2^{nd} position of the chamber 2′ has said coil spring 34 be turned, in relation to its position at said 1^{st} position of the chamber, in a plane through said center axis 3. Said holder 38 is shaped in such a way that it allows a torsional turn of said coil spring 34. At said 2^{nd} position of the chamber 2′ is said holder 34′ positioned farthest from the end of said member 12. The change of the position of the holder 38, 38′ is done by a stop 39. This enables the sealing to be unstressed at said position, and this enlarges life time. See FIG. 5B for the holder 38, 38′ in its end position and its retracted position, farthest from the end of the member 12. The diameter of said O-ring is ‘h’. In this drawing only one member is shown—no other members are shown.

FIG. 2 shows the combination as view X of FIG. 1. Not shown is the sealing 7 of said piston 1, 1′. Shown is said combination at a 1^{st} longitudinal/circular position of the chamber with a chamber radius ‘a’, and at a 2^{nd} longitudinal/circular position of the chamber with a chamber radius ‘b’—in between is the center lines 29, 30 of the chamber 2, 2′. The circle 32, 32′ shows the sealing of the O-ring 6, 6′ against the inner chamber wall 4, 4′, the diameters ‘j’, ‘k’ of the O-ring 6, 6′ at a 1^{st} and 2^{nd} longitudinal/circular position of the chamber resp. radius ‘a’>radius ‘b’, the coil spring 34, 34′ at the 1^{st} and 2^{nd} longitudinal/circular position of the chamber, respectively, the center lines 36, 36′ of the O-ring 6, 6′, respectively, the lines 35, 35′ of the coil spring 34, 34′, resp.

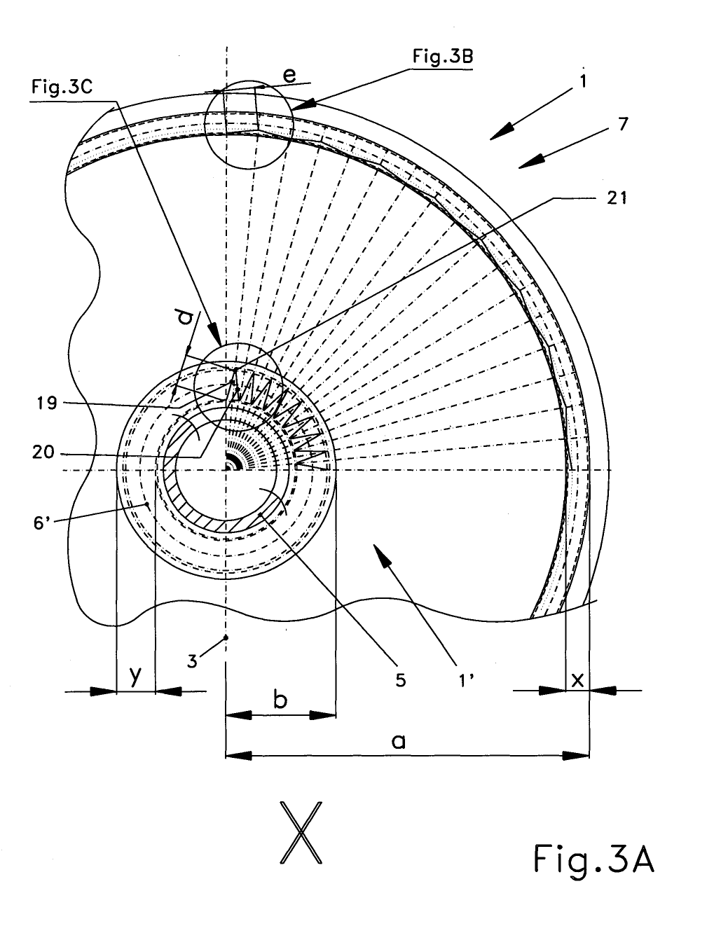

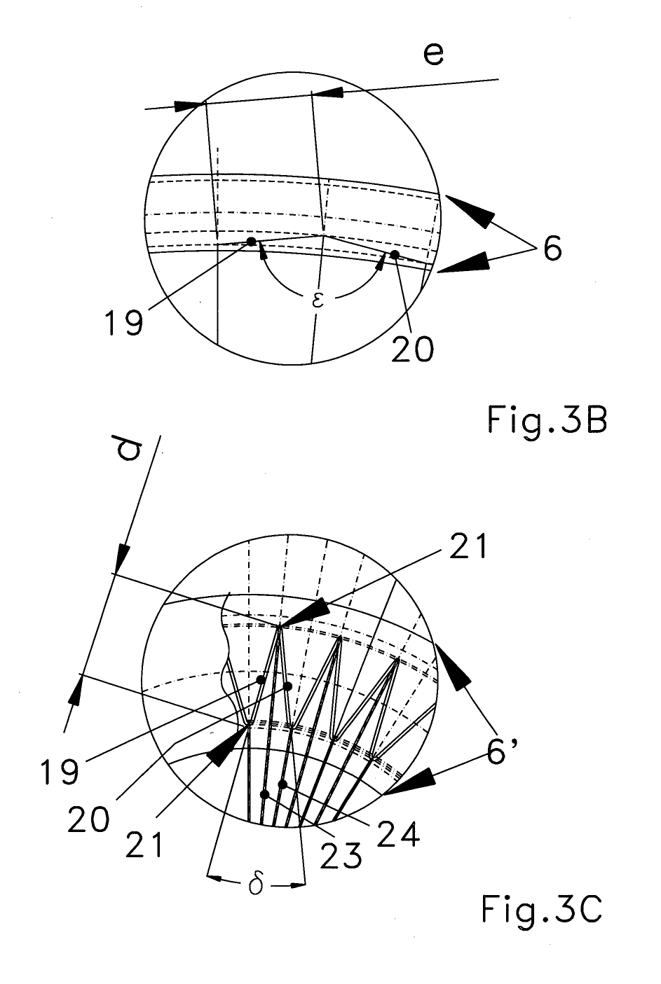

FIG. 3A shows schematically the X view of FIG. 1. One quarter with details of the sealing 7 is shown. Neither arms 12 nor the suspension 14 is shown: please see FIG. 2. The O-ring 6′ at a second longitudinal position has a big diameter ‘y’, and this thickness is being used to enabling the embeddiness of a shade folded sealing 7 by vulcanization into said O-ring 6′. Each fold 21 is comprises two adjacent unstressed sealing section planes 19 and 20, resp. of flexible sealing material. There are totally 34 folds 21. The center axis 3 and the piston rod 5.

FIGS. 3B and 3C shows details of said fold 21 which comprises two adjacent unstressed sealing section planes 19 and 20, resp. of flexible sealing material. The in-between angle δ, at a 2^{nd} longitudinal/circular position of the chamber is smaller than the same in-between angle ε when the piston 1 is on a first longitudinal position. The angle ε is less than 180°. The length of the unstressed flexible sealing 7 material ‘e’ (FIG. 3B), when the piston 1 is at a first longitudinal position, is approx. the same as length ‘d’ (FIG. 3C) when said piston 1 is at a second longitudinal position. The transitions 21 and 22, resp. of each adjacent pair 19 and 20, resp. are rounded off. Within the sealing 7 material are reinforcements positioned, e.g. 23 and 24, preferably positioned within the transitions 21 and 22, respectively. Reinforcements may also be within the section planes 19,20 (reinforcements not shown). The production of said last mentioned reinforcements is simple, as said sealing sections are not stressed in a plane through said planes—only to maintain the flatness of said sealing sections. The production of said reinforcements can be done by knitting.

The suspension 25 of the members 12 is having a tight fit with the piston rod 5. Five members 12 are shown. Said members 12 are communicating with an axle 26, which have a tight fit with the suspension 25. Said members can turn around said axles 26, the center line 27 of said axle 26.

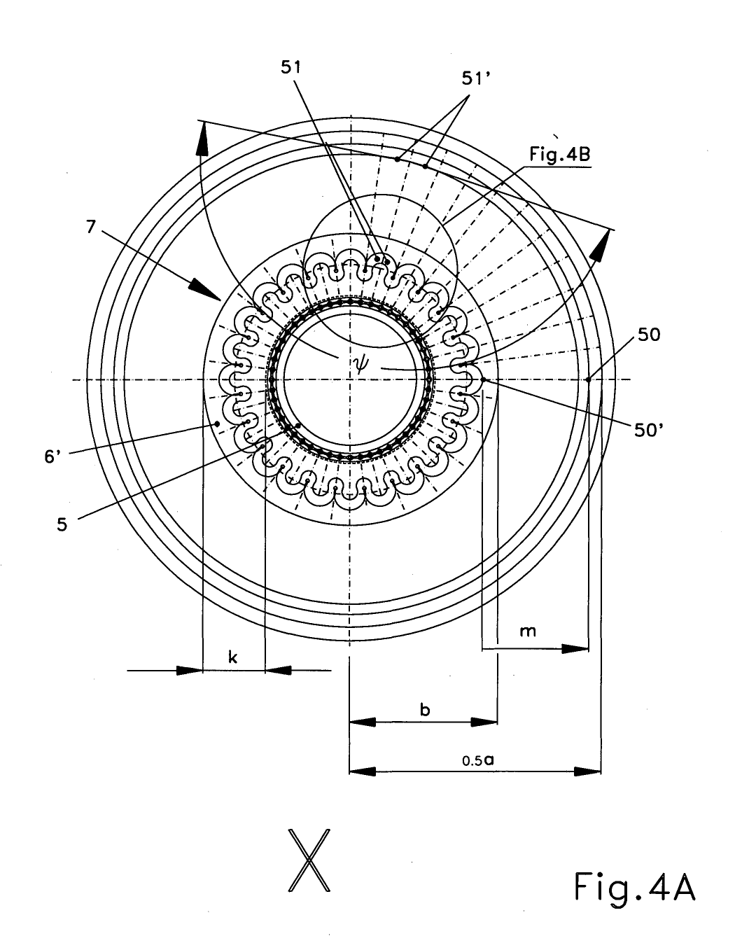

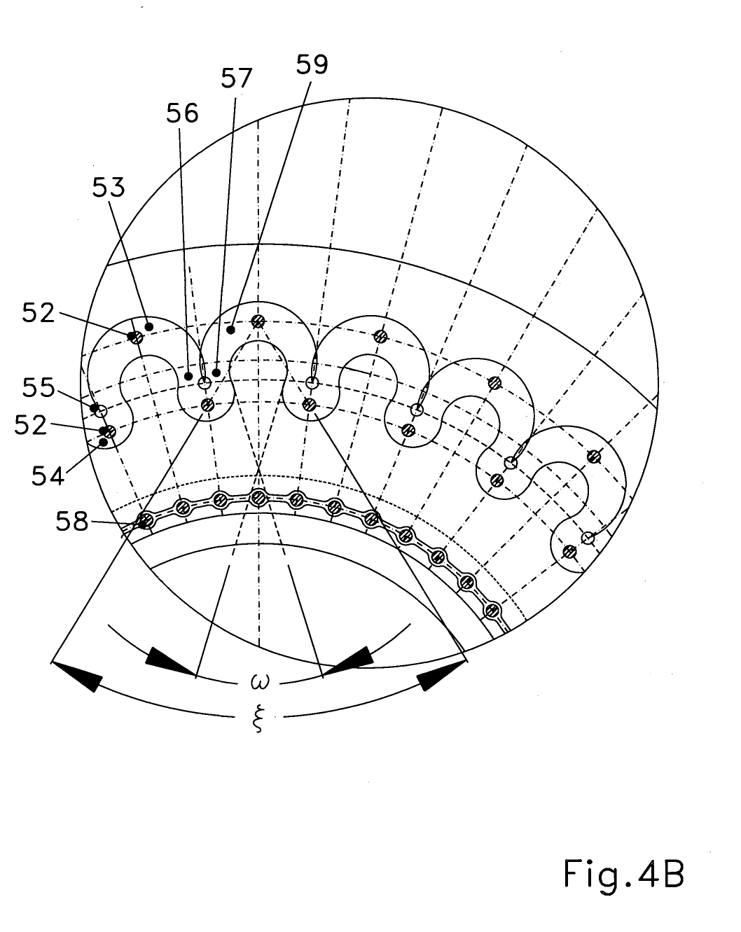

FIG. 4A shows a view X of FIG. 1, without showing members 12—only the enrolling type of the sealing 7, both at a second and a first longitudinal/circular position of the chamber. This type of sealing comprises sections 51, 51′, which at a second longitudinal position of the longitudinal/circular chamber have their production size, show to have been rolled together inwards in a direction to the piston rod 5, and farthest from the piston rod 5 have the separate part's O-ring 6′ as border. The angles between the reinforcements (ω) and the one between the surfaces (ξ) are shown in FIG. 4B, and are much smaller than 90°. Said sections 51 fill a complete circumference at a second chamber position. At a first longitudinal/circular position of the chamber are said sections 51′ rolled out into a continuous surface by bending the material only: the in-between angle ψ between two sections 51′ is just below 180°. It depends on the size of the diameter of the chamber at a second longitudinal/circular position of the chamber, as how long a part of said sections are in the direction to the center point in a transitional cross-section of the piston, thus how big the maximum size is of the circumference at a first chamber position. Also is said size depending on the maximum pressure of the pump, as said pressure works internally of the sealing in a direction opposite the folding in of said sealing: the smaller the maximum pressure of the medium is, the bigger the size of the circumference at a first longitudinal/circular position of the chamber can be, the bigger the possibility of saving energy. In relation to the size of the folding type of sealing, according FIGS. 3A-B (incl.) is the current maximum size at a first longitudinal/circular position of the chamber approximately ½ of that (size ‘a’). The ‘b’ size is the same as in FIGS. 3A-B (incl.). The width ‘k’ of the O-ring 6′. The change of position ‘m’ of the outer border 50′,50 of the sealing 7.

FIG. 4B shows an enlargement of the production size and shape of the sealing 7 of said piston shown in FIG. 4A at a second longitudinal/circular position of the chamber. More details are shown here, e.g. the reinforcement strings 52, on the middle of circle segments 53 and 54. On top of the sealing 7 are said ends of the reinforcements 52 shown with reference 58. From a second to a first longitudinal/circular position of the chamber is the rolling out of the production shape of said sealing type as follows: both angles ω and ξ at a second longitudinal/circular position of the chamber become angle ψ, as shown in FIG. 4A at a first longitudinal/circular position of the chamber. In order to avoid cracks, holes 55 have been positioned at the end of two adjacently placed legs 56 and 57 (schematically drawn) of the circle segments 53 and 59.

FIG. 5A shows an enlarged detail of FIG. 1, where the inner wall 4 of the chamber 2 at a 1^{st} position of said chamber is sealingly communicating with the sealing 7 of the piston 1 by the separate part's O-ring 6. Said sealing comprises a reinforcement 9, and at least one layer of impervious elastically deformable material 8. Said reinforcement is an addition to the reinforcements in the folds 18 between sections 19, 20 (see FIG. 3C). The O-ring 6 is vulcanized to said sealing sections 8—see the hatch differences. The O-ring 6 is supported by a coil spring 34 (schematically drawn). Said coil spring has a part 44 of the circleround cross-section, which can turn over an angle ζ in order to support the expansion of the O-ring 6—this is done here by torsioning a coil of said coil spring—other support methods are possible too. The member 12 comprises a portion 37 which is formed with a shaped holder 38 which has a similar circle round shape as the outside shape of said coil spring, optimizing the support of the coil spring 34. The center 17 of said O-ring, and the center 48 of the coil spring 34.

FIG. 5B shows an enlarged detail of FIG. 1, where the piston 1′ is at a 2^{nd} longitudinal/circular position of the chamber of the chamber 2′. FIG. 5B has the same scale as FIG. 5A. The piston rod 5, and the internal wall 4′ of the chamber 2′. The O-ring 6′ is engaging sealingly said internal wall 4′. The member 12′ is positioned almost parallel to the piston rod 5. The portion 37 has been retracted (36′) from the end of the member 12′, so as to enable the sealing 7 is not stretching the length ‘f’, which otherwise would shorten the life time of the piston 1′. The length ‘f’ is shown being the length between said center 48 and the center 48′ of the retracted portion 37′. The stop 39, which is mounted on the piston rod 5, is stopping the synchrone movement of holder 38 with the movement of member 12′, and ends with the position of holder 38′, when the piston is moving to a second longitudinal/circular position of the chamber. The holder 38,38′ may have a spring 40 (not shown), which reverses the repositioning of holder 38′ to 38, when the piston is moving to a 1^{st} longitudinal/circular position of the chamber.

FIG. 5C shows schematically the suspension of the O-ring 6 to a member 12. The hinge 63 is at one end 62 embedded in the O-ring 6 (preferably in the center 17), while at the other end rotatably mounted in turning point 64. At the opposite end of said turning point 64 is a hinge 65 mounted. The last mentioned hinge 65 is mounted on the portion 37 of the member 12. Preferably is the hinge 63 rotatable over angle γ in a plane perpendicular to the axle 13 of a member 12, around an internal axle 68 of said turning point 64, and said axle 68 is positioned in the center point 48 of the coil spring 34′. The hinge 63 may be divided in 2 parts, which can slide in each other (not shown), so as to adapt dimensions.

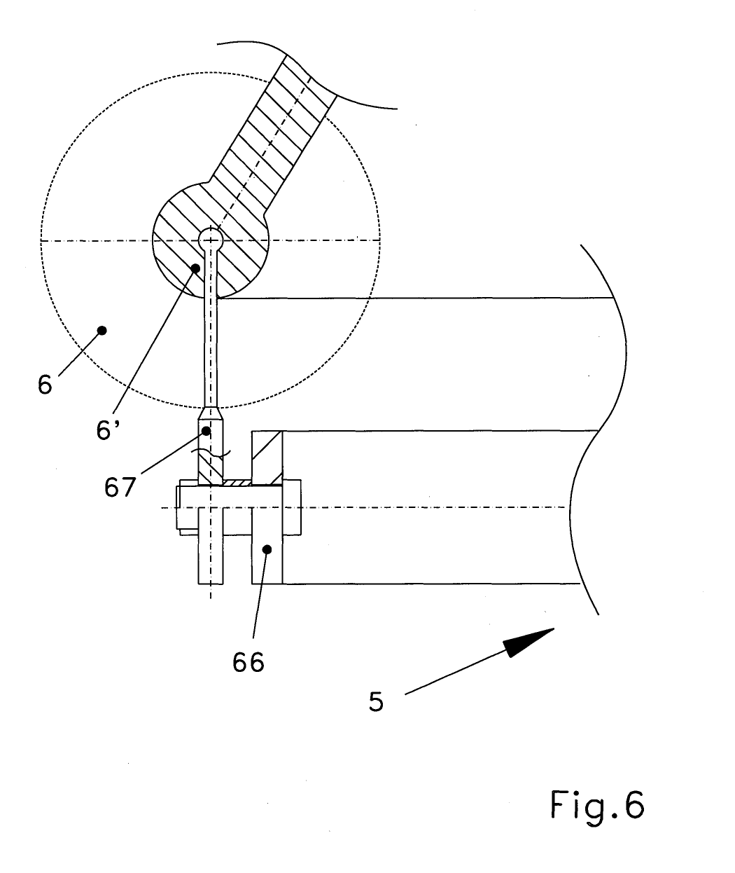

FIG. 6 shows an alternative solution for the coil spring 34, 34′. The flat spring 66 is mounted by a bolt and nut connection on a member 67, which at the other side is vulcanized on the O-ring 6, 6′. Said flat spring 66 is mounted at its other side on the piston rod 5 (not shown).

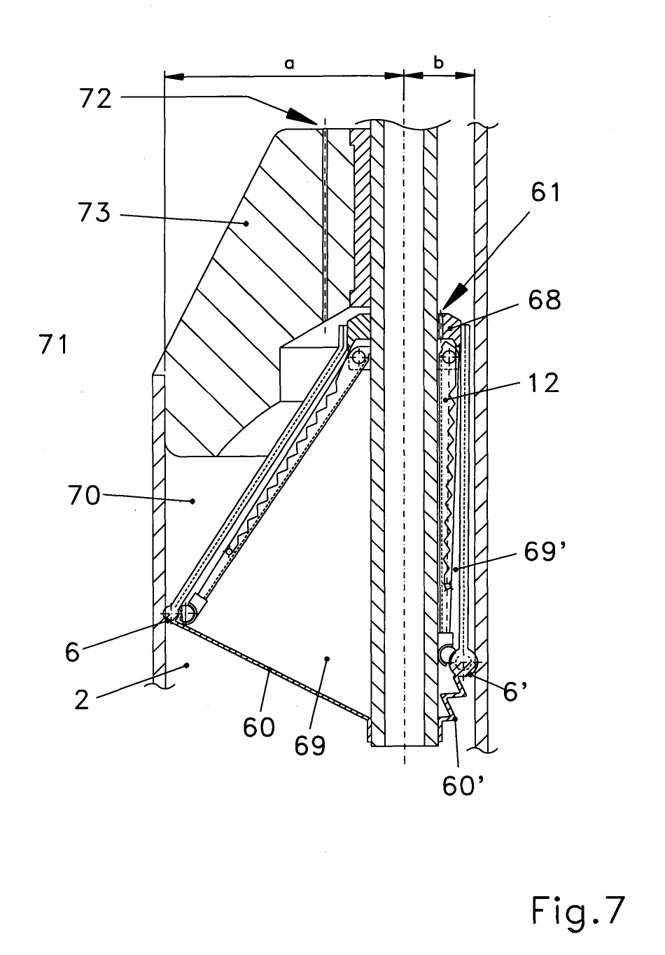

FIG. 7 shows the piston 1 of FIG. 1, now further comprising a sealing surface 60, 60′ embedded in the O-ring 6, 6′ and vulcanized onto the piston rod 5. Said sealing surface 60′ is folded when the piston 1′ is at a 2^{nd} longitudinal/circular position of the chamber. The venting hole 61, which is positioned in the suspension 68 of the members 12, and connects the inner volume 69, 69′ of said piston and said sealing surface 60,60′, with the outer part 70 of the chamber 2, and the atmosphere 71, through the venting hole 72 in the cab 73.

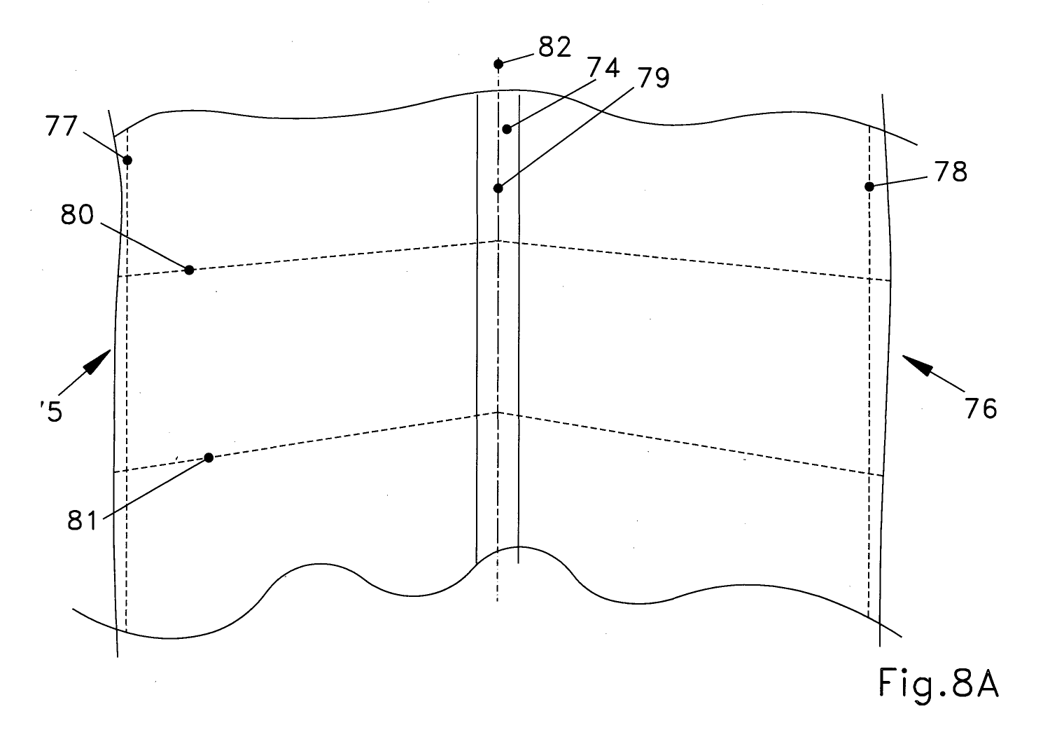

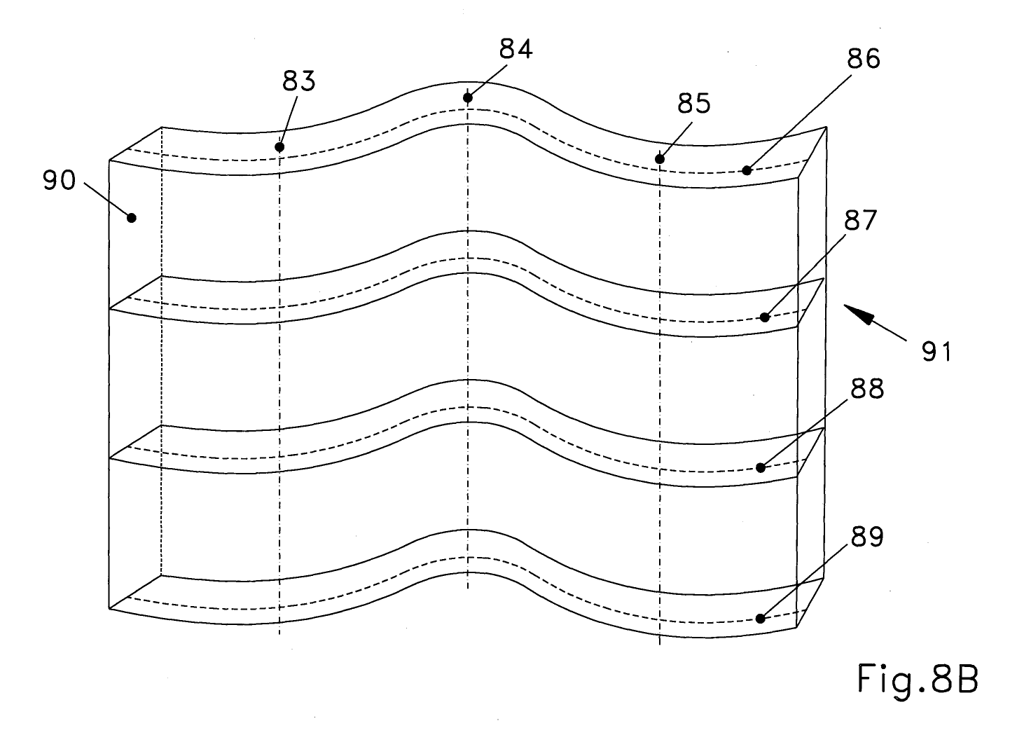

FIG. 8A shows schematically a part of a plane-type sealing. The fold 74 connects two planes 75 and 76, which comprise reinforcement strings 77 and 78, both parallel to said fold 74 (alike as earlier shown in FIG. 3C). Said fold has a reinforcement 79. Additionally reinforcement strings 80 and 81, which are connected to said reinforcement strings 77, 78 and 79, and shown perpendicular to said reinforcement strings 77, 78 and 79. This 90° angle may be different (not shown). The center axis 82 of the fold 74.

FIG. 8B shows schematically a part of a curved-type sealing. The vertically shown reinforcements 83, 84 and 85 are positioned alike shown in FIG. 4B. The reinforcement strings 86, 87, 88 and 89 are shown laying a certain constant distance from each other, and are connected to said reinforcement strings 83-85 (incl.), and shown perpendicular to said reinforcement strings. This 90° angle may be different (not shown). Said strings 86-89 (incl.) are positioned a certain distance from the other surface 90 of the sealing 91.

1. A piston-chamber combination comprising:
a chamber defined at least by an inner chamber wall; and
a piston in said chamber configured to be engagingly movable relative to said inner chamber wall at least between a first longitudinal position and a second longitudinal position of said chamber, said chamber having cross-sections of different cross-sectional areas and differing circumferential lengths at said first longitudinal position and said second longitudinal position, and at least substantially continuously different cross-sectional areas and circumferential lengths at intermediate longitudinal positions between said first longitudinal position and said second longitudinal position, a cross-sectional area and circumferential length at said second longitudinal position being less than a cross-sectional area and circumferential length at said first longitudinal position, said piston comprising a member for suspension of a sealing, said member being rotatable, and said sealing comprising a separate part engaging said inner chamber wall of said chamber and said sealing being made of elastically deformable impervious material, and mounted on a piston rod, said piston having a production-size of said separate part and said sealing in a stress-free and undeformed state thereof in which a circumferential length of said piston is approximately equivalent to the circumferential length of said inner chamber wall at said second longitudinal position, said piston being expandable from said production size in a direction transversally with respect to a longitudinal/circular direction of said chamber to provide an expansion of sealing of said piston from said production size thereof during relative movements of said piston from said second longitudinal position to said first longitudinal/circular position, wherein at one end, closest to a second longitudinal/circular position of said chamber, said sealing being embedded in said separate part, said sealing of said piston comprising sealing sections in a direction along said piston rod, said sealing being divided in said sealing sections over a circumference of said sealing, and, an angle in-between two adjacent sealing sections is less than 180°, wherein at one other end, closest to a first longitudinal/circular position of said chamber, said sealing is divided in said sealing sections over said circumference of said sealing, and, another angle in-between two adjacent sealing sections is greater than said angle.

2. A piston-chamber combination according to claim 1, wherein closest to said first longitudinal/circular position of said chamber is a cross-sectional diameter of said separate part is greatest, and closest to said first longitudinal/circular position of said chamber (2) a cross-sectional diameter of said separate part is less than said cross-sectional diameter of said separate part at said second longitudinal/circular position of said chamber.

3. A piston-chamber combination according to claim 1, wherein said sealing sections are plane sections, said plane sections having transitions in-between said sealing sections, said plane sections and said transitions comprising reinforcements, said reinforcements communicating with each other.

4. A piston-chamber combination according to claim 1, wherein said sealing sections are curved sections and said sealing sections comprising in turning centers reinforcements positioned in a direction along said piston rod, said sealing sections comprising reinforcements, said reinforcements communicating with each other.

5. A piston-chamber combination according to claim 1, wherein said angles are between two adjacently positioned section planes.

6. A piston-chamber combination according to claim 4, wherein said angles are between two adjacently positioned reinforcement ends of turning centers in a transversal cross-section.

7. A piston-chamber combination according to claim 1, further comprising turning points for the sealing and for said member, wherein said turning points are positioned adjacent to each other.

8. A piston-chamber combination according to claim 1, further comprising a coil spring for suspending said separate part, said coil spring comprising a part which can turn over an angle.

9. A piston-chamber combination according to claim 1, wherein said member further comprises a shaped holder, wherein said holder has a circle round shape corresponding to an outside shape of a coil spring.

10. A piston-chamber combination according to claim 9, wherein said shaped holder is part of a portion of said member, wherein said portion is retractable, by a stop mounted on said piston rod.

11. A piston-chamber combination according to claim 1, wherein the member has an angle of approximately 60° with a center axis of said piston rod.

12. A piston-chamber combination according to claim 1, wherein a turning point, spot of the sealing, is positioned very nearly the center of an axle of the member.

13. A pump for pumping a fluid, the pump comprising:
a piston-chamber combination comprising a chamber defined by at least an inner chamber wall and a piston in said chamber configured to be engagingly movable relative to said inner chamber wall at least between a first longitudinal position and a second longitudinal position of said chamber, said chamber having cross-sections of different cross-sectional areas and differing circumferential lengths at said first longitudinal position and said second longitudinal position, and at least substantially continuously different cross-sectional areas and circumferential lengths at intermediate longitudinal positions between said first longitudinal position and said second longitudinal position, a cross-sectional area and circumferential length at said second longitudinal position being less than a cross-sectional area and circumferential length at said first longitudinal position, said piston comprising a member for suspension of a sealing, said member being rotatable, and said sealing comprising a separate part engaging said inner chamber wall of said chamber and said sealing being made of elastically deformable impervious material, and mounted on a piston rod, said piston having a production-size of said separate part and said sealing in a stress-free and undeformed state thereof in which a circumferential length of said piston is approximately equivalent to said circumferential length of said chamber wall at said second longitudinal position, said piston being expandable from said production size in a direction transversally with respect to a longitudinal/circular direction of said chamber to provide an expansion of sealing of said piston from said production size thereof during relative movements of said piston from said second longitudinal position to said first longitudinal/circular position, wherein at one end, closest to a second longitudinal/circular position of said chamber, said sealing being embedded in said separate part, said sealing of said piston comprising sealing sections in a direction along said piston rod, said sealing being divided in said sealing sections over a circumference of said sealing, and, an angle in-between two adjacent sealing sections is less than 180°, wherein at one other end, closest to a first longitudinal/circular position of said chamber, said sealing is divided in said sealing sections over said circumference of said sealing, and, another angle in-between two adjacent sealing sections is greater than said angle;
means for engaging said piston from a position outside said chamber;
a fluid entrance connected to said chamber and comprising a valve means; and
a fluid exit connected to said chamber, said separate part sealingly engaging said inner chamber wall of said chamber, at least from said first longitudinal/circular position to said second longitudinal/circular position of the chamber.

14. A pump according to claim 13, wherein said engaging means has an outer position where said piston is at said first longitudinal/circular position of said chamber, and an inner position where said piston is at said second longitudinal/circular position of said chamber.

15. A pump according to claim 14, wherein said engaging means has an outer position where said piston is at said second longitudinal/circular position of said chamber, and an inner position where said piston is at said first longitudinal/circular position of said chamber.

16. A shock absorber comprising:
a piston-chamber combination comprising a chamber defined by at least an inner chamber wall and a piston in said chamber configured to be engagingly movable relative to said inner chamber wall at least between a first longitudinal position and a second longitudinal position of said chamber, said chamber having cross-sections of different cross-sectional areas and differing circumferential lengths at said first longitudinal position and said second longitudinal position, and at least substantially continuously different cross-sectional areas and circumferential lengths at intermediate longitudinal positions between said first longitudinal position and said second longitudinal position, a cross-sectional area and circumferential length at said second longitudinal position being less than a cross-sectional area and circumferential length at said first longitudinal position, said piston comprising a member for suspension of a sealing, said member being rotatable, and said sealing comprising a separate part engaging said inner chamber wall of said chamber and said sealing being made of elastically deformable impervious material, and mounted on a piston rod, said piston having a production-size of said separate part and said sealing in a stress-free and undeformed state thereof in which a circumferential length of said piston is approximately equivalent to said circumferential length of said chamber wall at said second longitudinal position, said piston being expandable from said production size in a direction transversally with respect to a longitudinal/circular direction of said chamber to provide an expansion of sealing of said piston from said production size thereof during relative movements of said piston from said second longitudinal position to said first longitudinal/circular position, wherein at one end, closest to a second longitudinal/circular position of said chamber, said sealing being embedded in said separate part, said sealing of said piston comprising sealing sections in a direction along said piston rod, said sealing being divided in said sealing sections over a circumference of said sealing, and, an angle in-between two adjacent sealing sections is less than 180°, wherein at one other end, closest to a first longitudinal/circular position of said chamber, said sealing is divided in said sealing sections over said circumference of said sealing, and, another angle in-between two adjacent sealing sections is greater than said angle;
a means for engaging said piston from a position outside said chamber, wherein said engaging means has an outer position where said piston is at said first longitudinal/circular position of said chamber, and an inner position where said piston is at the second longitudinal/circular position, said separate part is sealingly engaging said inner chamber wall of said chamber, at least from said first longitudinal/circular position of said chamber and said second longitudinal/circular position of said chamber.

17. A shock absorber according to claim 16, further comprising a fluid entrance connected to said chamber and comprising a valve means.

18. A shock absorber according to claim 14, further comprising a fluid exit connected to said chamber and comprising a valve means.

19. A shock absorber according to claim 16, wherein said chamber and said piston form an at least substantially sealed cavity comprising a fluid, said fluid being compressed when said piston moves from said first longitudinal/circular position to said second position of said chamber.

20. A shock absorber according to claim 16, further comprising a means for biasing said piston toward said first longitudinal/circular position of said chamber.

21. An actuator comprising:
a piston-chamber combination comprising a chamber defined by at least an inner chamber wall and a piston in said chamber configured to be engagingly movable relative to said inner chamber wall at least between a first longitudinal position and a second longitudinal position of said chamber, said chamber having cross-sections of different cross-sectional areas and differing circumferential lengths at said first longitudinal position and said second longitudinal position, and at least substantially continuously different cross-sectional areas and circumferential lengths at intermediate longitudinal positions between said first longitudinal position and said second longitudinal position, a cross-sectional area and circumferential length at said second longitudinal position being less than a cross-sectional area and circumferential length at said first longitudinal position, said piston comprising a member for suspension of a sealing, said member being rotatable, and said sealing comprising a separate part engaging said inner chamber wall of said chamber and said sealing being made of elastically deformable impervious material, and mounted on a piston rod, said piston having a production-size of said separate part and said sealing in a stress-free and undeformed state thereof in which a circumferential length of said piston is approximately equivalent to said circumferential length of said chamber wall at said second longitudinal position, said piston being expandable from said production size in a direction transversally with respect to a longitudinal/circular direction of said chamber to provide an expansion of sealing of said piston from said production size thereof during relative movements of said piston from said second longitudinal position to said first longitudinal/circular position, wherein at one end, closest to a second longitudinal/circular position of said chamber, said sealing being embedded in said separate part, said sealing of said piston comprising sealing sections in a direction along said piston rod, said sealing being divided in said sealing sections over a circumference of said sealing, and, an angle in-between two adjacent sealing sections is less than 180°, wherein at one other end, closest to a first longitudinal/circular position of said chamber, said sealing is divided in said sealing sections over said circumference of said sealing, and, another angle in-between two adjacent sealing sections is greater than said angle;
a means for engaging the piston from a position outside said chamber;
a means for introducing fluid into said chamber to displace said piston between said first longitudinal/circular position and said second longitudinal/circular position of said chamber, said separate part sealingly engaging said inner chamber wall of said chamber, from said second longitudinal/circular position to said first longitudinal/circular position of said chamber or from said first longitudinal/circular position to said second longitudinal/circular position of said chamber.

22. An actuator according to claim 21, further comprising a fluid entrance connected to said chamber and comprising a valve means.

23. An actuator according to claim 21, further comprising a fluid exit connected to said chamber and comprising a valve means.

24. An actuator according to claim 21, further comprising a means for biasing said piston toward one of said first longitudinal/circular position and said second longitudinal/circular position of said chamber.

25. An actuator according to claim 21, wherein said introducing means comprises a means for introducing pressurized fluid into said chamber.

26. An actuator according to claim 21, wherein said introducing means is adapted to introduce a combustible fluid into said chamber, and the actuator further comprises a means for combusting said combustible fluid.

27. An actuator according to claim 21, further comprising a crank adapted to translate translation of said piston into a rotation of said crank.
